(19) United States
(12) Patent Application Publication
(10) Pub. No.: US 2008/0102428 A1
(43) Pub. Date: May 1, 2008

(54) System and Method for Providing a User-Centric Interactive Learning Environment

(75) Inventors: Jonathon D. Levy, Charlestown, MA (US); Amelia Newbury, Somerville, MA (US); Katherine Carlone, Cambridge, MA (US); John S. Forth, Boston, MA (US)

Correspondence Address: BROMBERG & SUNSTEIN LLP, 125 SUMMER STREET, BOSTON, MA, 02110-1618, US

(73) Assignee: MONITOR COMPANY GROUP LIMITED PARTNERSHIP, Cambridge, MA (US)

(21) Appl. No.: 11/924,253

(22) Filed: Oct. 25, 2007

Related U.S. Application Data
(60) Provisional application No. 60/862,968, filed on Oct. 25, 2006.

(51) Int. Cl. G09B 5/02

(52) U.S. Cl. 434/322

(57) ABSTRACT

A method of providing a personalized learning experience, under computer program control, to a user includes displaying graphically a listing of subject areas and their abstraction levels. Subject areas and abstraction levels may also be displayed via a concept map. Selection by the user of a desired subject area and a desired abstraction level from the graphical display moves program control of the learning experience to the desired subject area and the desired abstraction level.

### CROSS-REFERENCE TO RELATED APPLICATIONS

This patent application claims priority under 35 U.S.C. § 119(e) to U.S. Provisional Patent Application No. 60/862,968 filed Oct. 25, 2006, the disclosure of which is hereby incorporated by reference.

### FIELD OF THE INVENTION

The present invention generally relates to learning environments, and, more particularly, to user-centric interactive learning environments.

### BACKGROUND OF THE INVENTION

It is known in the prior art to provide learning systems via a computer. A prior art system by the present inventors is disclosed in U.S. Pat. No. 7,082,418.

Learning in a network environment typically is a linear experience in which the users' learning sequence is dictated by a Subject-Matter Expert (SME) or an Instructional Designer's view of the “right way” to approach and learn the content. It is not possible for a user to easily choose her own path through the educational content, to cater to her own preferred learning styles, or to focus where her interest and needs direct her.

Network learning environments using simulations impose a branching and predetermined set of options for all users in such simulated environments, requiring the users to proceed all the way through a decision path even if in the course of proceeding through the content, they come to understand that a prior navigation decision was a wrong one. Simpler approaches, based on one-dimensional tables of contents, sometimes allow the user to go to any node in the table of contents, but these approaches do not provide the context required to allow the user to make meaningful decisions as to preferred learning styles or particular areas of interest and needs.

None of these approaches support the user-centric notion that the individual is the most important element in the learning equation, and sometimes is the only person who truly understands what she needs to know. Traditional solutions do not provide sufficient learning environment contextual information about, or user control over, the educational content for the user to make these decisions.

### SUMMARY OF THE INVENTION

In accordance with one aspect of the invention, a method of providing a personalized learning experience, under computer program control, to a user, includes displaying graphically a listing of subject areas offered to the user, each subject area having a plurality of distinctly labeled abstraction levels, also displayed graphically. The method also includes receiving a graphical selection by the user of a desired subject area and a desired abstraction level from the displayed listing, and, on receipt of a user command in relation to such selection, moving program control of the experience to the desired subject area and the desired abstraction level, so as to enable the user to proceed in a direction and manner of the user's choosing consistent with the user's needs of the moment.

In accordance with related embodiments, displaying the listing and the abstraction levels may include displaying the listing along a first axis and displaying the abstraction levels along a second axis orthogonal to the first axis. Displaying the listing and the abstraction levels may further include displaying a matrix in which a separate graphically accessible region is defined by the intersection of a specific subject area on the first axis and a specific abstraction level on the second axis, such separate region being graphically selectable, so that selection of the desired subject area and the desired abstraction level may be accomplished by graphical selection of the region in the matrix corresponding to the desired subject area and the desired abstraction level. The method may further include displaying an indicator in the matrix to identify the location of program control to the user. The method may further include displaying a summary of the desired subject area following receiving the graphical selection and before receipt of the user command. At least one of the abstraction levels may include chunks, and the abstraction levels displayed include at least two members selected from the group including overview, core concepts, practice case, examples, and tools. One of the abstraction levels may be core concepts and one chunk may include exposition, contextualization, interaction, and framing. The interaction may include a capability of finishing a task for the user. One of the abstraction levels may be practice case and one chunk may include research, brainstorming, evaluation, and recommendation. One of the abstraction levels may be practice case and one chunk may be graphically presented in a team room. One of the abstraction levels may be practice case and the method may further include permitting selection of a portion of one chunk in a recursive manner. At least one of the abstraction levels may be divided into sections. One of the abstraction levels may be overview and one of the sections may include use of a visual metaphor.

In accordance with another aspect of the invention, a method of providing a personalized learning experience, under computer program, to a user, includes providing an interactive learning environment in a computer system, the environment established by a series of interactive media elements, the elements covering selected subject areas offered to the user, wherein each of the subject areas is systematically divided into abstraction levels including at least two members selected from the group including overview, core concepts, practice case, examples, and tools. The method further includes providing in the environment a graphical navigation tool permitting the user to navigate graphically in the environment to any desired subject area and any desired abstraction level.

In accordance with related embodiments, the method further includes displaying the listing along a first axis and displaying the abstraction levels along a second axis orthogonal to the first axis. Displaying the listing and the abstraction levels may further include displaying a matrix in which a separate graphically accessible region may be defined by the intersection of a specific subject area on the first axis and a specific abstraction level on the second axis, such separate region being graphically selectable, so that selection of the desired subject area and the desired abstraction level may be accomplished by graphical selection of the region in the matrix corresponding to the desired subject area and the desired abstraction level. The method may further include displaying an indicator in the matrix to identify the location of program control to the user. At least one of the abstraction levels may include chunks. One of the abstraction levels may be core concepts and one chunk may include exposition, contextualization, interaction, and framing. The interaction may include a capability of finishing a task for the user. One of the abstraction levels may be practice case and one chunk may include research, brainstorming, evaluation, and recommendation. One of the abstraction levels may be practice case and one chunk may be graphically presented in a team room. One of the abstraction levels may be practice case and the method further include permitting selection of a portion of one chunk in a recursive manner. At least one of the abstraction levels may be divided into sections. One of the abstraction levels may be overview and one of the sections may include use of a visual metaphor.

In accordance with another aspect of the invention, a computer program product for providing a personalized learning experience to a user includes a computer usable medium having computer readable program code thereon. The computer readable program code includes program code for displaying graphically a listing of subject areas offered to the user, each subject area having abstraction levels, also displayed graphically, including at least two members selected from the group including overview, core concepts, practice case, examples, and tools. The computer readable program code also includes program code for permitting graphical selection by the user of a desired subject area and a desired abstraction level from the displayed listing, whereupon, on such selection, program control of the experience moves to the desired subject area and the desired abstraction level.

In accordance with related embodiments, program code for displaying the listing and the abstraction levels may include program code for displaying the listing along a first axis and displaying the abstraction levels along a second axis orthogonal to the first axis. Program code for displaying the listing and the abstraction levels may further include program code for displaying a matrix in which a separate graphically accessible region may be defined by the intersection of a specific subject area on the first axis and a specific abstraction level on the second axis, such separate region being graphically selectable, so that selection of the desired subject area and the desired abstraction level may be accomplished by graphical selection of the region in the matrix corresponding to the desired subject area and the desired abstraction level. The computer readable program code may further include program code for displaying an indicator in the matrix to identify the location of program control to the user. At least one of the abstraction levels may include chunks. One of the abstraction levels may be core concepts and one chunk may include exposition, contextualization, interaction, and framing. The interaction may include a capability of finishing a task for the user. One of the abstraction levels may be practice case and one chunk may include research, brainstorming, evaluation, and recommendation. One of the abstraction levels may be practice case and one chunk may be graphically presented in a team room. One of the abstraction levels may be practice case and the computer readable program code may further include program code for permitting selection of a portion of one chunk in a recursive manner. At least one of the abstraction levels may be divided into sections. One of the abstraction levels may be overview and one of the sections may include use of a visual metaphor.

In accordance with another aspect of the invention, a method of providing a personalized learning experience, under computer program control, to a user, includes displaying graphically a listing of subject areas offered to the user, wherein presentation of each subject area is selectable by the user according to a matrix of attributes affecting the presentation. The matrix includes at least two dimensions selected from the group consisting of mode, learning goal, application goal, and entry point. The method includes receiving a graphical selection by the user of a desired subject area and a desired attribute from each dimension of the matrix, and on receipt of a command in relation to such selection, presenting content consistent with such selection, so as to enable the user to select both the subject area and a plurality of attributes affecting presentation to the user of the desired subject area.

In accordance with related embodiments, displaying graphically the list of subject areas includes displaying a concept map of the subject areas. Receiving a graphical selection by the user of the desired subject area includes the selection via graphical indication in the concept map. Graphical selection from the user via graphical indication in the concept map may indicate a realm of the concept map to be displayed and may cause display of the realm in response thereto. The mode dimension of the matrix includes at least two attributes selected from the group consisting of watch and listen, interact, read, discuss, and suggest. The learning goal dimension of the matrix may includes at least two attributes selected from the group consisting of awareness, basic knowledge, common sense, deep knowledge, and creative knowledge. The matrix includes at least two attributes selected from the group consisting of apply subskills, integrate subskills, recognize and apply, deepen and apply, and extend and apply. The entry point dimension of the matrix includes at least two attributes selected from the group consisting of general concept, specific concept, example, guided practice, and open practice.

### BRIEF DESCRIPTION OF THE DRAWINGS

The foregoing advantages of the invention will be appreciated more fully from the following further description thereof with reference to the accompanying drawings wherein:

FIG. 1 shows a home page of a learning environment according to illustrative embodiments of the present invention;

FIG. 2 shows the home page with one subject area selected according to illustrative embodiments of the present invention;

FIG. 3 shows abstraction levels for the subject areas according to illustrative embodiments of the present invention;

FIG. 4 shows an Introduction subject area with one section selected in an Overview level according to illustrative embodiments of the present invention;

FIG. 5 shows a map page of the learning environment according to illustrative embodiments of the present invention;

FIG. 6 shows a Buying Process subject area with one section selected in the Overview level according to illustrative embodiments of the present invention;

FIG. 7 shows the Buying Process subject area with another section selected in the Overview level according to illustrative embodiments of the present invention;

FIG. 8 shows the Buying Process subject area with a Core Concepts level selected according to illustrative embodiments of the present invention;

FIG. 9 shows an exposition portion of the Core Concepts level according to illustrative embodiments of the present invention;

FIG. 10 shows an interaction portion of the Core Concepts level according to illustrative embodiments of the present invention;

FIG. 11 shows a framing portion of the Core Concepts level according to illustrative embodiments of the present invention;

FIG. 12 shows the Buying Process subject area with one section selected in a Practice Case level according to illustrative embodiments of the present invention;

FIG. 13 shows a team room in the Practice Case level according to illustrative embodiments of the present invention;

FIG. 14 shows the Buying Process subject area with one section selected in an Examples & Insights level according to illustrative embodiments of the present invention;

FIG. 15 shows the Buying Process subject area with one section selected in a Tools level according to illustrative embodiments of the present invention;

FIG. 16 shows a Next Steps subject area with one section selected in the Overview level according to illustrative embodiments of the present invention;

FIG. 17 shows a flow chart of a user experience according to illustrative embodiments of the present invention;

FIG. 18 shows a flow chart of a user experience according to illustrative embodiments of the present invention;

FIG. 19 shows a flow chart of a user experience in the Core Concepts level according to illustrative embodiments of the present invention;

FIG. 20 shows a flow chart of a user experience according to illustrative embodiments of the present invention;

FIG. 21 shows a flow chart of a user experience according to illustrative embodiments of the present invention;

FIG. 22 shows a flow chart of a user experience in the Practice Case level according to illustrative embodiments of the present invention;

FIG. 23 shows a flow chart of a user experience in the Tools level according to illustrative embodiments of the present invention; and

FIG. 24 shows a flow chart of data flow according to illustrative embodiments of the present invention;

FIG. 25 shows a user interface wireframe for selection of interactive learning content, presentation mode, learning and application goals, and content entry point in accordance with an illustrative embodiment of the present invention;

FIG. 26 shows a shows a user interface wireframe, in accordance with the embodiment of FIG. 25, for selection of presentation mode, learning and application goals, and content entry point after an item of content has been selected;

FIG. 27 shows a user interface wireframe with a concept map for selection of interactive learning content in accordance with another illustrative embodiment of the present invention;

FIG. 28 shows a high-level hardware architecture according to an illustrative embodiment of the present invention; and

FIG. 29 shows a block diagram of a software architecture according to an illustrative embodiment of the present invention.

### DESCRIPTION OF ILLUSTRATIVE EMBODIMENTS

Definitions. As used in this description and the accompanying claims, the following terms shall have the meanings indicated, unless the context otherwise requires:

An “abstraction level” is a plane of presentation of a subject area, which may exist at a desired position between theoretical understanding and practical application of the subject area. An abstraction level may be an overview, or core concepts, or a practice case, or examples and insights, or tools for practical application of the subject area. These are exemplary abstraction levels. Numerous other levels of abstraction may be employed as may be appropriate to the subject areas of the learning environment or the user's needs of the moment (although they may coincide or overlap with the foregoing), such as summary, rules, patterns, standards, and case history.

A “section” is a subdivision of a given abstraction level. In other words, an abstraction level may be further divided into what we call “sections”. The nature of the sections necessarily depends on the abstraction level in question. As an example, the “overview” abstraction level may be divided into sections such as “at a glance”, “guiding questions”, “the big picture”, and “key elements”. Similarly, the “examples and insights” abstraction level may be divided into sections such as “industry examples”, “expert insights”, and “tips from practitioners”.

A “chunk” is a unit of presentation of a particular abstraction level, and necessarily depends on the abstraction level in question. For example, at the “core concepts” abstraction level, a chunk may include portions such as exposition, contextualization, interaction, and framing. Also, as an example, at the “practice case” abstraction level, a chunk may include a number of portions, wherein each portion is an experience in a distinct area of a team room, one portion involving research, another one, brainstorming, and yet another one, evaluation, and a fourth one, recommendation.

“Interactive media elements” include hyperlinked web pages, Flash or similar content employing vector-graphic animation technology, and other multimedia content capable of being accessed in an interactive computer learning environment.

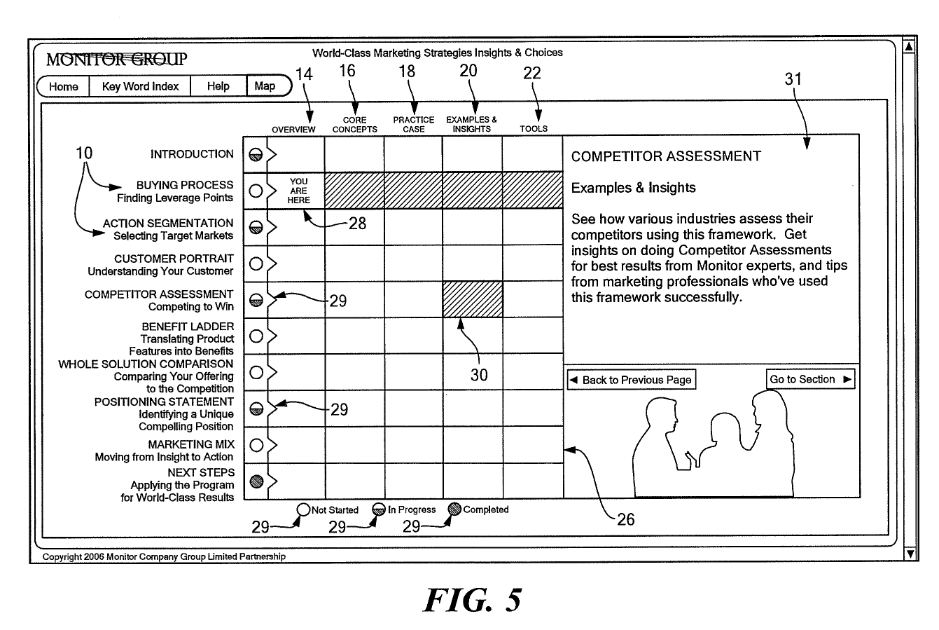

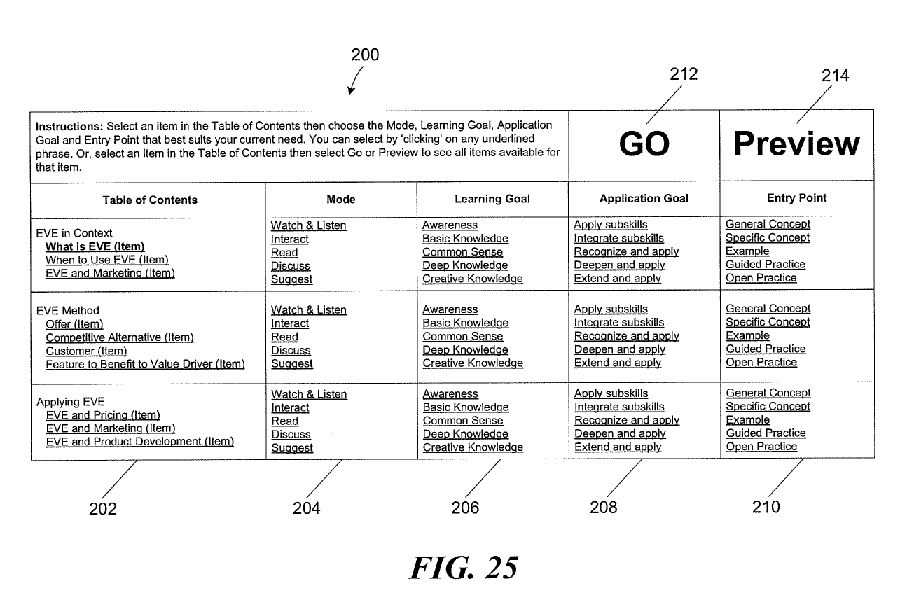

A “matrix” is a graphical array, having a plurality of dimensions, that allows for display and user selection of graphically accessible regions defined by the intersections of dimensions along two or more axes. In the embodiment of FIG. 5, directed to accessing learning content, there are two dimensions, namely subject area along one axis and abstraction level along another axis; user selection of a region in the matrix results in selection of the corresponding item of subject area and abstraction level. In the embodiment of FIG. 25, directed both to accessing learning content and affecting its presentation, there are dimensions for subject area (table of contents), mode, learning goal, application goal, and entry point. Thus, in FIG. 25, the dimensions other than subject area are directed to presentation. The matrix of FIG. 25, permits user selection of an item of subject area and an attribute from each displayed presentation dimension; collectively these user selections define content and presentation of content to the user.

An “attribute” associated with a specific presentation dimension in a matrix having dimensions associated with content presentation defines an aspect of presentation of content to the user. Attributes include:
a. For the dimension “Mode,” which allows the user to choose how the learning content is presented, attributes include “watch & listen”, “interact”, “read”, discuss”, and “suggest”;
b. For the dimension “Learning goal,” which allows the user to choose the desired depth or emphasis of learning, attributes include “awareness”, “basic knowledge”, “common sense”, “deep knowledge”, and creative knowledge”;
c. For the dimension “Application goal,” which allows the user to choose learning content directed to a desired use, attributes include “apply subskills”, “integrate subskills”, “recognize and apply”, “deepen and apply”, and “extend and apply”.
d. For the dimension “Entry point,” which allows the user to choose at which point in the subject matter the user would like instruction to begin, attributes include “general concept”, “specific concept”, “example”, “guided practice”, and “open practice”.

A “concept map” is a graphical representation of concepts and their interrelationships in learning content. In a concept map, concepts are shown connected to other concepts by labeled connections, the labels providing information as to the type of relationship that connects them. In embodiments of the invention herein, concept maps may display areas or items of learning content along with how they are related to each other, and may allow the user to navigate through and choose specific areas or items of learning content.

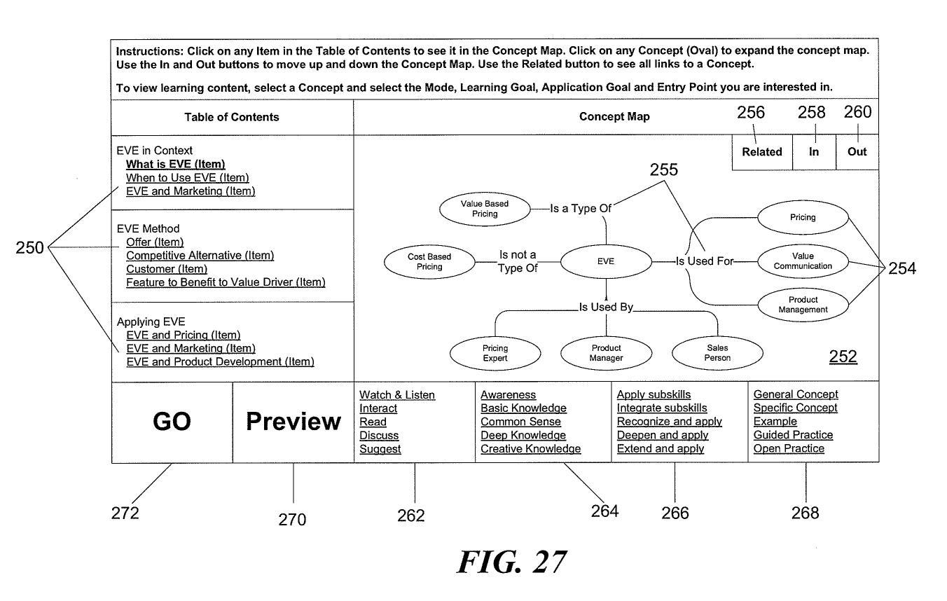

A “realm” of a concept map is a group of items of learning content at a shared level of abstraction. For example, in FIG. 27, a realm showing subject area EVE with its relationships to other items of learning content is displayed in the concept map. If the user selects EVE in the concept map and then selects the “In” button, the displayed concept map relates to a different realm at a different abstraction level of subject area EVE.

Embodiments of the present invention provide an educational content navigation system in an interactive learning environment that places the user in a position of control over the content. Any and all parts of the content can be visible and navigable from any other part of the content. A holistic view of where the user is in relation to all of the content is preserved as the user explores any content area of interest. The trees are always seen in the context of the forest, and direct access to any content area to address the user's current individual knowledge need can be provided with a single mouse click. This navigation structure allows the user to easily select any item of content that addresses the needs she has identified.

This navigation system is further embodied in the design of simulations that facilitate a recursive experience. The user is able to back up and select different pathways in a simulation without restarting the experience. This provides a close simulation of a user's actions in a real world scenario where a mistake would be rectified and another path taken as soon as a better solution was recognized. The path is defined by the user, not by the SME or instructional designer.

Embodiments of the present invention provide an interactive learning environment to a user via a single product that delivers both the educational content as well as its practical application to the user or company in the context of the company's business. The environment may include a blend of simulation, games, storytelling, interactive scenarios, case-based learning and visual and conceptual metaphors. Various embodiments apply to learning environments in a wide variety of subject areas. For illustrative purposes, a portion of a learning environment directed to marketing strategy and a portion of a learning environment directed to value-based pricing is discussed in detail below. It will be apparent to those skilled in the art, however, that educational content in any other subject area may be used with various embodiments of the present invention. Details of illustrative embodiments are discussed below.

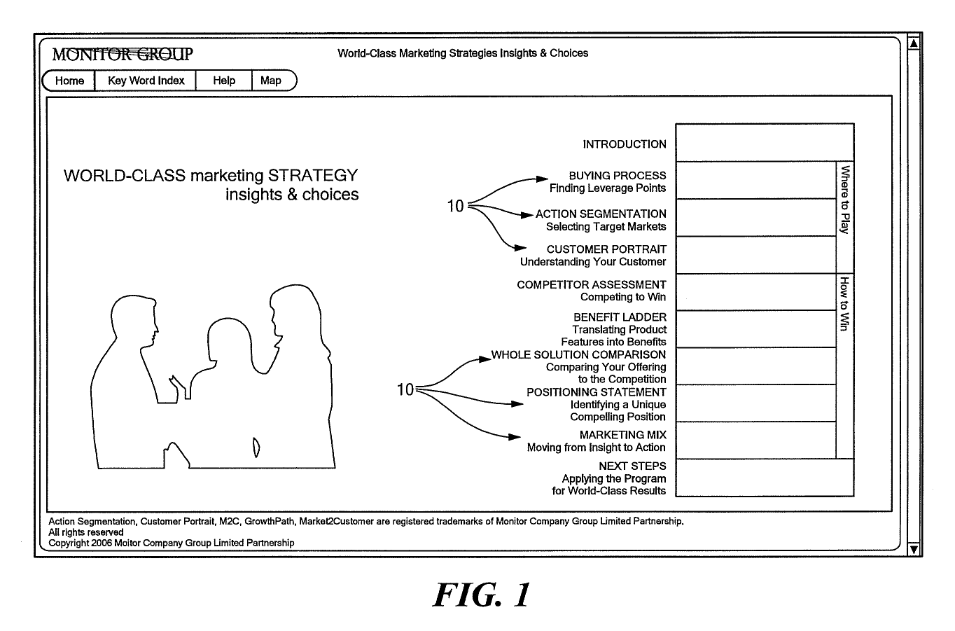

FIG. 1 shows a home page of a learning environment directed to marketing strategy according to illustrative embodiments of the present invention. As shown, the marketing strategy content is divided into modules or subject areas 10. The subject areas 10 provide the user with a particular framework that allows the user to create the marketing strategy best suited for meeting the user's and/or company's individual needs.

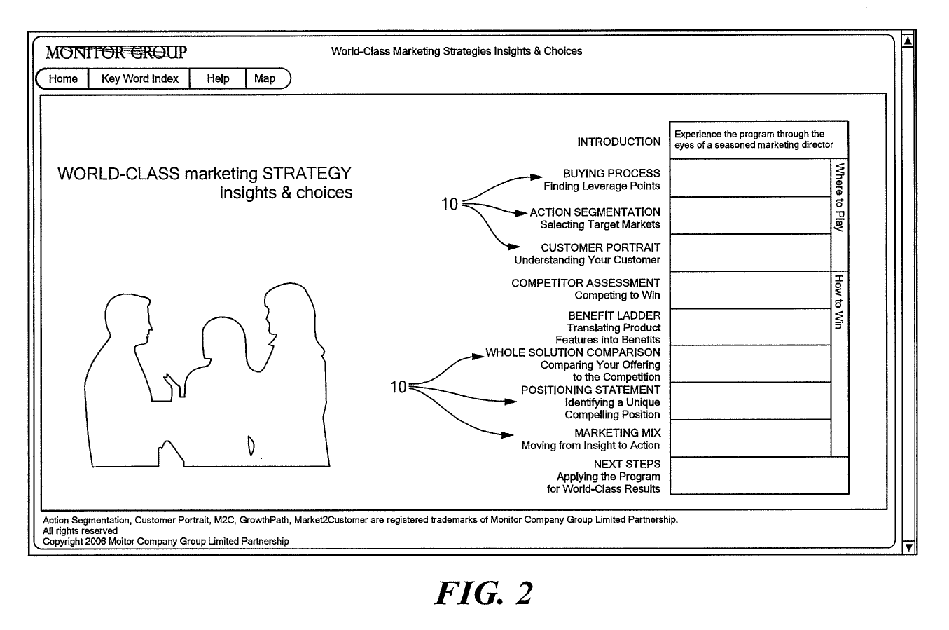

As shown in FIG. 2, the user has selected the Introduction subject area that allows the user to experience the program through the eyes of a seasoned marketing director. Alternatively, or in addition, the user may select from any of the subject areas 10 that guide the user from a buying process through to a marketing mix and the next steps in applying the program for results. The environment provides the user with a brief description of the content of each module before the user experience moves to the desired subject area 10.

In various illustrative embodiments of the present invention and at various pages within an embodiment, selection of a subject area or other content item, and a user command to move the learning experience to the selected subject area or other content item may be accomplished through separate user actions, or content selection and moving the experience may result from a single user action.

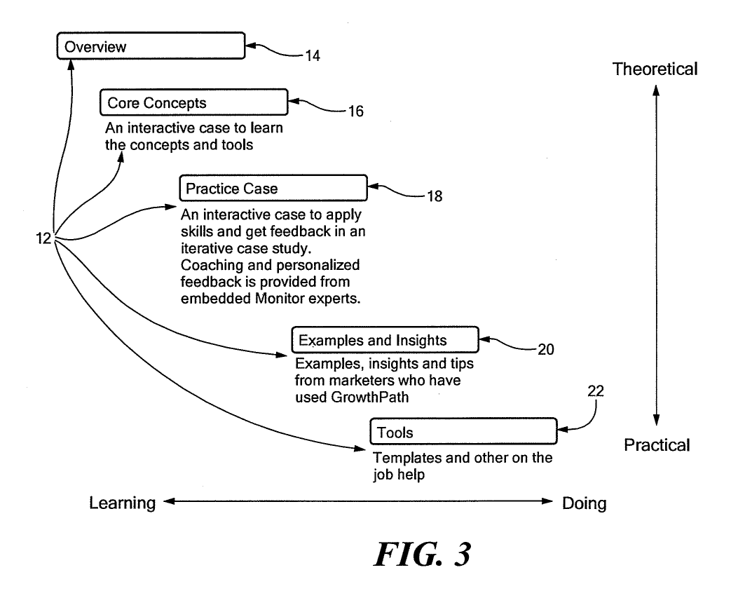

The subject areas 10 may be further divided into increasingly applied abstraction levels 12, as shown in FIG. 3. The abstraction levels 12 may include Overview 14, Core Concepts 16, Practice Case 18, Examples and Insights 20 and Tools 22. The various abstraction levels 12 are discussed in more detail below. This particular framework allows the user to move from a theoretical to a practical approach, e.g., from an abstract learning of the concepts to an implementation of the concepts in a real world environment.

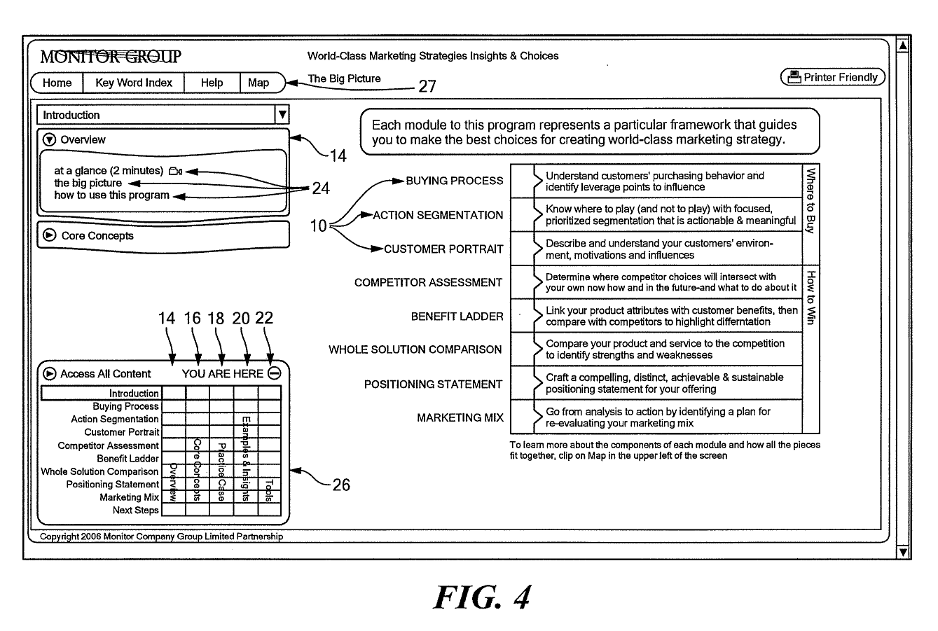

If the Introduction subject area is selected from the home page (e.g., as shown in FIG. 2), a new page is displayed, as shown in FIG. 4, showing the Introduction subject area with its available abstraction levels 14-22 in an indicator portion of the page (e.g., shown in the left side of FIG. 4) and with the content displayed in another portion of the page (e.g., shown in the right side of FIG. 4). Each of the various abstraction levels 14-22 may be further divided into sections 24 that may be selected by the user with content suitable for that abstraction level. In addition to showing the currently selected subject area 10 and abstraction level 12, the program may also provide a matrix 26 in the indicator portion of the page graphically showing the user where he or she is in relation to the other subject areas 10 and abstraction levels 12 when viewing the content of the currently selected subject area 10, abstraction level 12 and section 24. The user may navigate to any desired subject area 10 and abstraction level 12 by simply selecting that region within the matrix 26. Alternatively, the user may select a Map button 27, which is typically displayed during the experience, to view a map page having an expanded image of the matrix 26.

FIG. 5 shows a map page displaying an expanded image of matrix 26. The map page displays where the user currently is in the learning environment by highlighting an area 28 with a “You Are Here” and highlighting other abstraction levels 12 within the current subject area 10. The map page also displays what the user has done in the environment with status symbols 29. In this example, the user has not started using the Buying Process subject area 10 as shown by the open, Not Started circle 29 to the left of the highlighted area 28. Similarly, the user has already started using the Action Segmentation, the Competitor Assessment, and the Positioning Statement subject areas 10 as shown by the half-filled, In Progress circle 29 to the right of the titles for these areas 10. The Next Steps area is shown to be completed by the user, as shown by the filled-in, Completed circle 29.

If the user desires to move to another subject area, the user may select a graphical region 30 within the matrix 26. The program may display a summary of the content of this region 30 in a display window portion 31 of the map page. The user may then select to go to this subject area 10 and abstraction level 12, may select another region of matrix 26, or return to the previous page the user was viewing. Thus, the map page provides the user with a tool that is both informational and navigational. The environment provided by this embodiment permits a user to navigate easily from one subject area to another and also in a given subject area to move, for example, from learning to action abstraction levels.

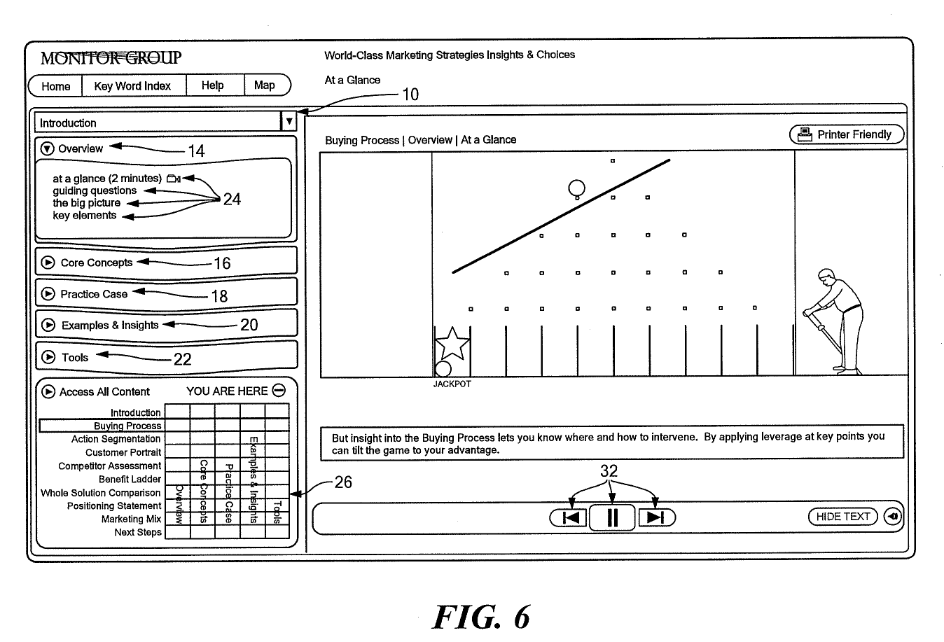

FIG. 6 shows the Buying Process subject area 10 with one of the sections 24 selected in the Overview abstraction level 14. The Overview abstraction level 14 provides an introduction to each subject area 10, its value, how it relates to the other subject areas 10, and how it fits into the overall marketing strategy process. The Overview abstraction level 14 may have several sections 24, such as an At a Glance section, a Guiding Questions section, The Big Picture section and a Key Elements section. The At a Glance section may provide the user with graphical or visual metaphors to aid in the understanding of the subject area 10, as shown in FIG. 6.

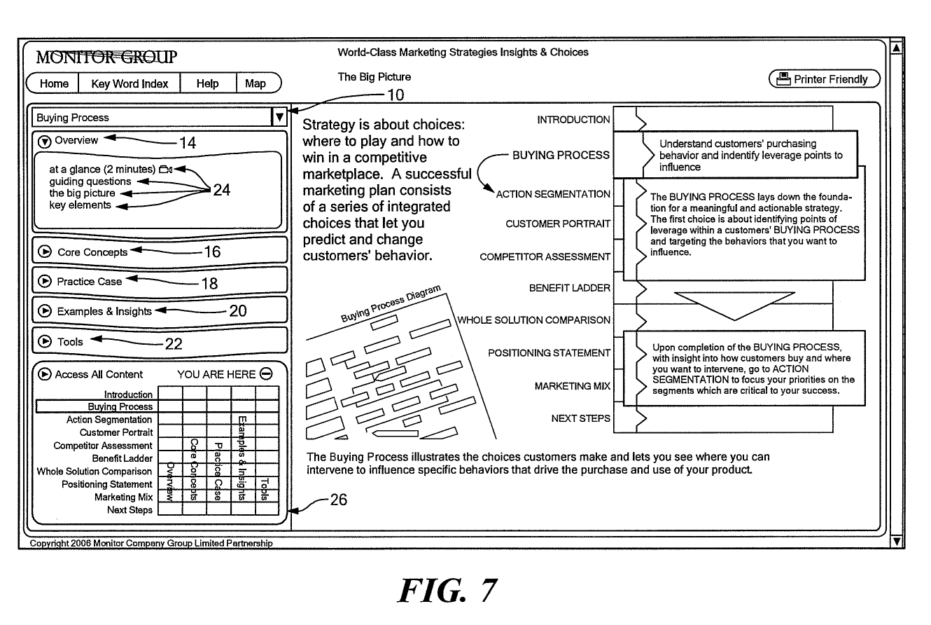

The user may select additional sections 24 to use within the Overview abstraction level 14, such as The Big Picture section 24 shown in FIG. 7. The user may navigate to other abstraction levels within the Buying Process subject area 10 by selecting the title of the abstraction level 16-22 under the Buying Process subject area 10, e.g., selecting the Core Concepts abstraction level 16 shown in the left side of FIG. 7. Alternatively, the user may select a region within matrix 26, e.g., where the Core Concepts abstraction level and the Buying Process subject area 10 intersect.

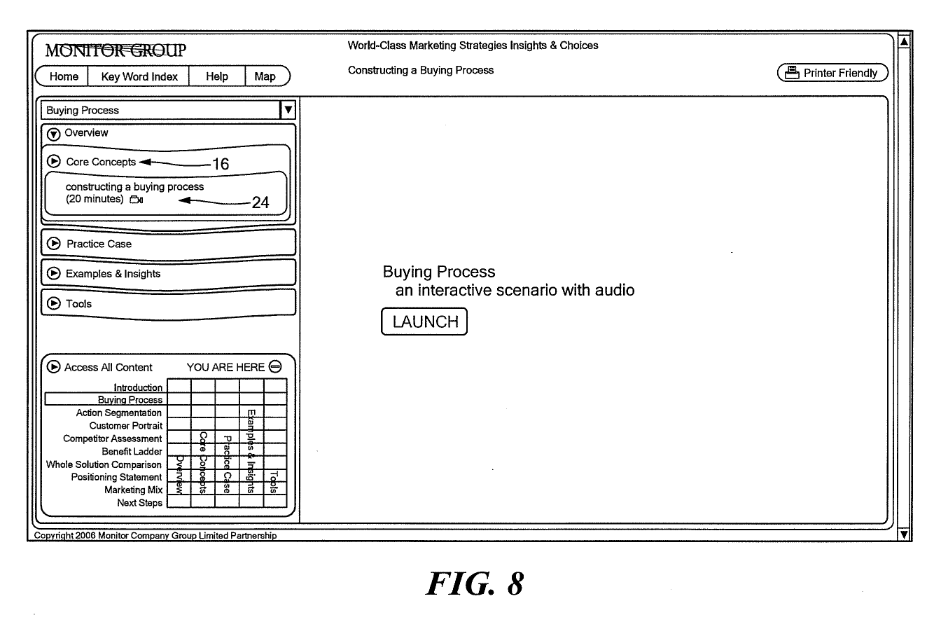

FIG. 8 shows the Buying Process subject area 10 with the Core Concepts abstraction level 16 selected. The Core Concepts abstraction level 16 allows the user to learn the concepts and tools necessary to provide an effective marketing strategy. For example, the user is provided with the interactive case shown at section 24 where the user acts as a member of a marketing team in a fictitious company, e.g., a financial services company.

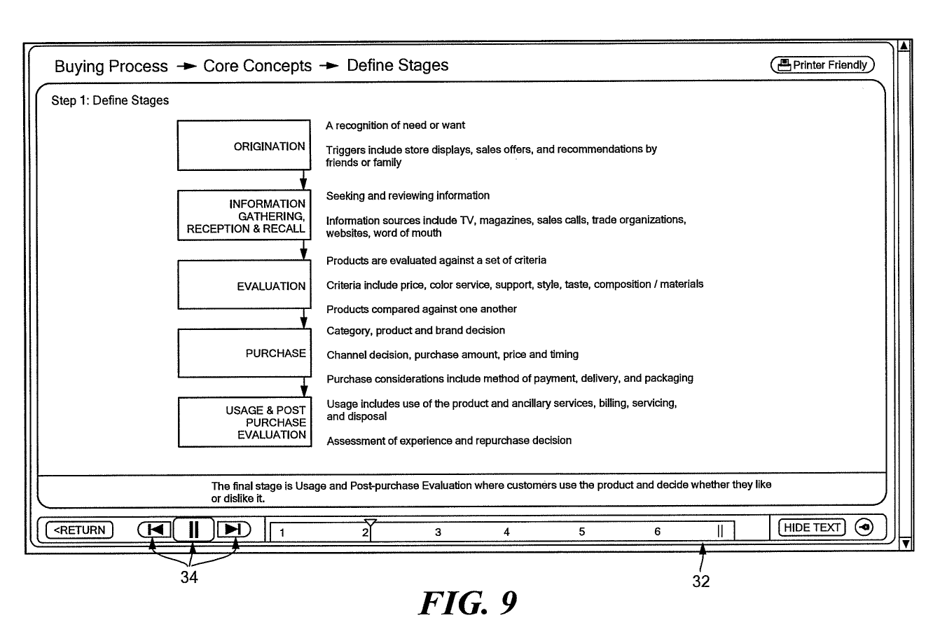

If the user launches the interactive case, a new page is displayed that shows the content of the Core Concept abstraction level 16, as shown in FIG. 9. The page displays the content in one portion of the page (e.g., shown in the upper portion of FIG. 9) and a status indicator bar 32 in another portion of the page (e.g., shown in the bottom portion of FIG. 9) that shows where the user is in the case study. In this example, the user is slightly beyond number two on status indicator bar 32 or about one-third of the way through the case. The user may select buttons 34, e.g., play, reverse, forward and pause, when viewing the content of the Core Concepts abstraction level 16. The user may also select to display text and/or to play audio of the content along with the visual content by pressing the hide text/display text button to the right of status indicator bar 32. The Core Concepts abstraction level 16 may be shown in segments or chunks, each chunk including exposition, contextualization, interaction and framing. FIG. 9 shows one example of the exposition portion which includes an introduction to various stages in the buying process, such as origination, information gathering, reception and recall, evaluation, purchase and usage and post purchase evaluation. The contextualization portion may include an embedded expert explaining how the various stages fit within the context of the buying process (not shown).

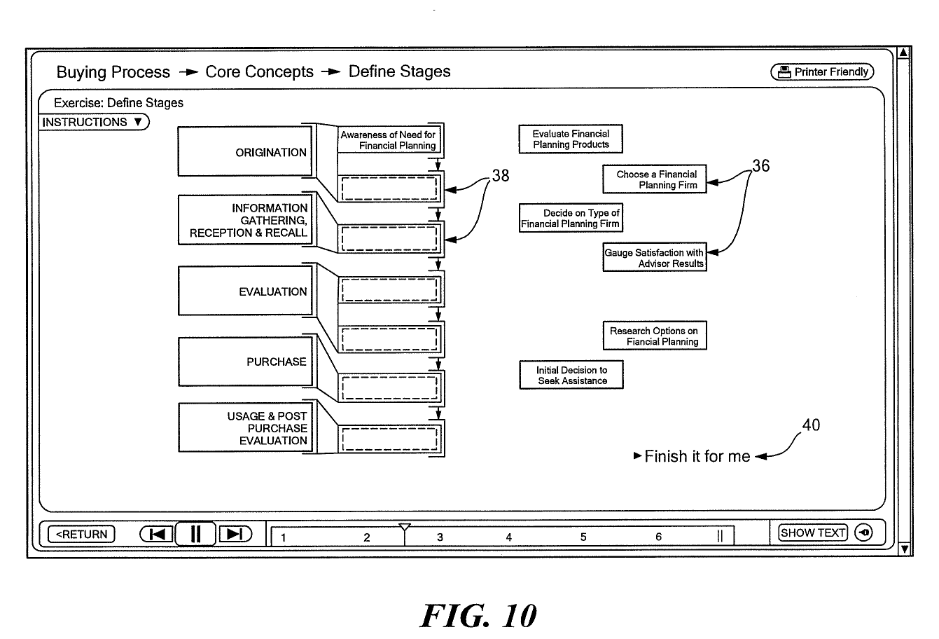

FIG. 10 shows one example of the interaction portion where the user is provided with examples 36 and asked to place each example 36 in the box 38 next to the correct corresponding stage, e.g., in a drag-and-drop type exercise. In this portion, there is a right and wrong answer and the user is provided with feedback as to whether their choice was correct or not. The user may proceed through this interactive process or may select a button 40 that finishes the interaction portion for the user.

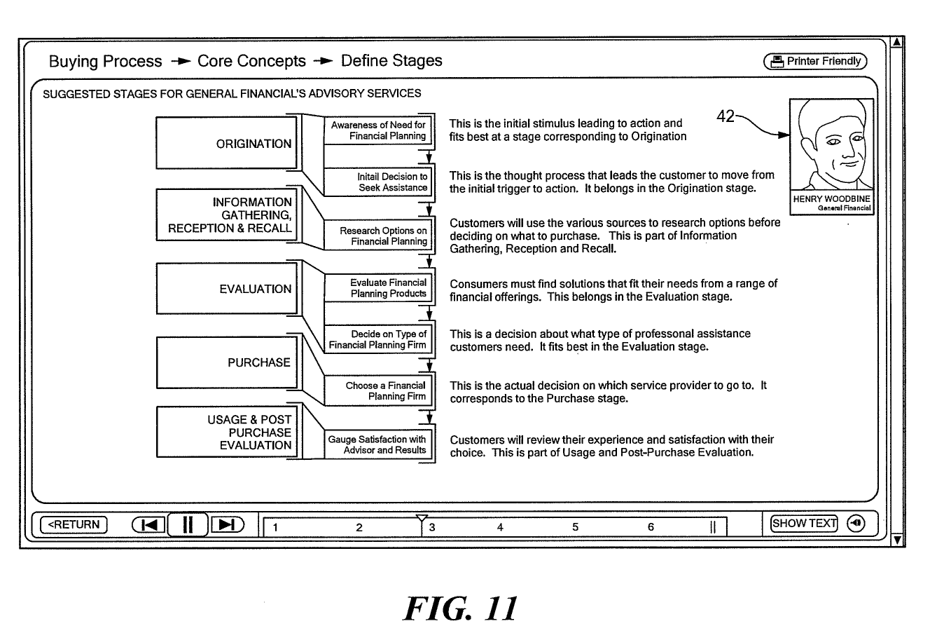

FIG. 11 shows one example of the framing portion, where an embedded expert 42 provides the user with an explanation of how and/or why the various examples 36 belong to the corresponding stages. At any time during the interactive case, the user may select to return to the previous page before the user launched the interactive case.

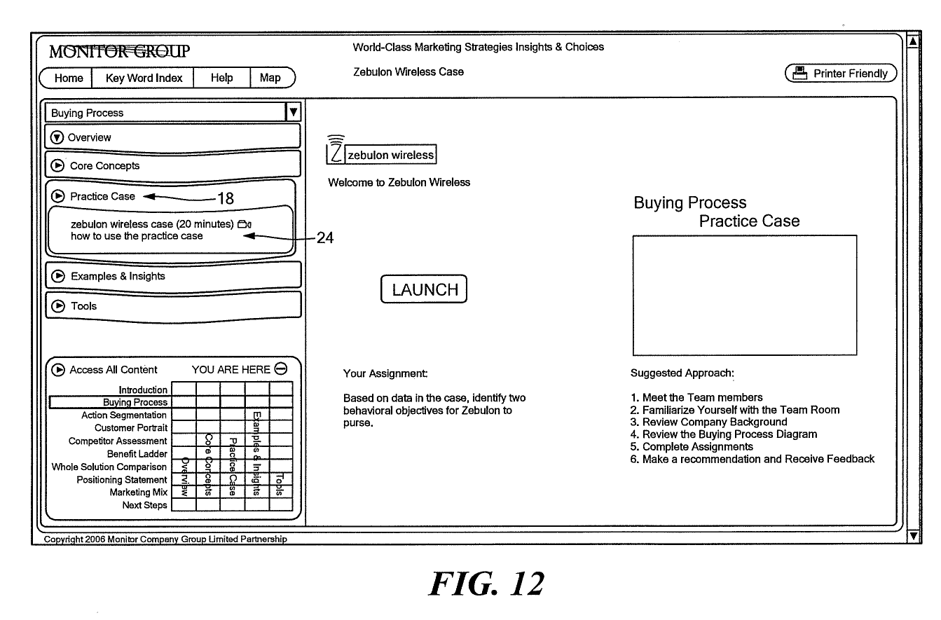

FIG. 12 shows the Buying Process subject area 10 with one section 24 selected in the Practice Case abstraction level 18 according to illustrative embodiments of the present invention. The Practice Case abstraction level 18 allows the user to apply the concepts and tools in an interactive case where the user leads a marketing team of a fictitious company, e.g., a mobile phone company. Users may apply their skills, make decisions, and get feedback in an interactive and iterative case study. The interactive case study environment allows recursive scenarios that mimic reality by allowing users to back up and change decisions once they see the consequences of their actions. Coaching and personalized feedback may be provided from embedded experts throughout the Practice Case abstraction level 18. The Practice Case abstraction level 18 is designed to take the user from understanding the concepts to being a practitioner.

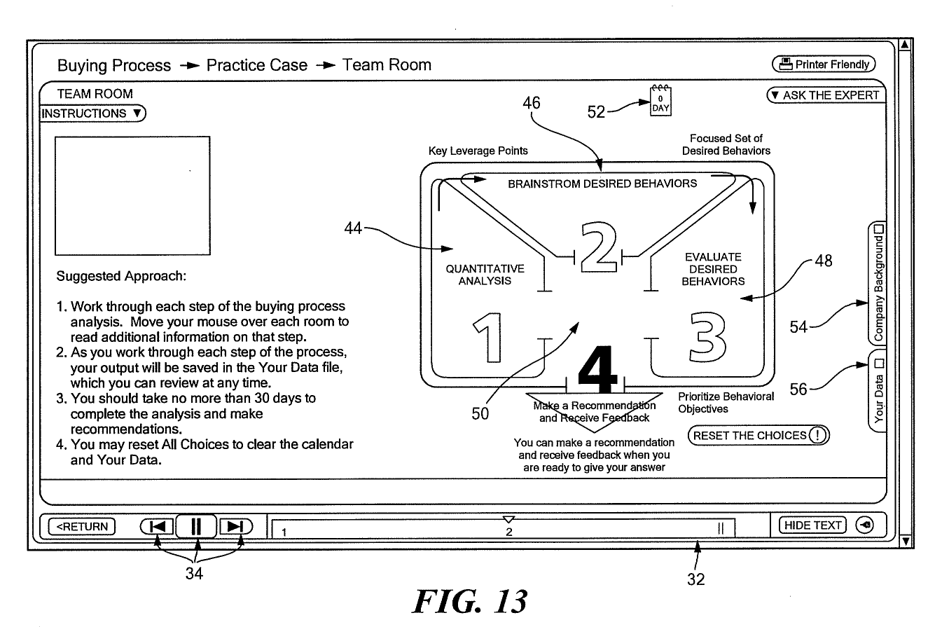

If the user launches the interactive case study, the user may choose to learn about the different members of the user's marketing team. A new page is then displayed that shows a team room of the Practice Case abstraction level 18, as shown in FIG. 13. The page displays the team room environment in one portion of the page (e.g., shown in the upper portion of FIG. 13) and a status indicator bar 32 in another portion of the page (e.g., shown in the bottom portion of FIG. 13) that shows where the user is in the case study. Similar to the interactive case in the Core Concepts abstraction level 16, the user may select buttons 34, e.g., play, reverse, forward and pause, when viewing the case study content. The user may also select to display text and/or to play audio of the content along with the visual content.

The Practice Case abstraction level 18 may be shown in segments or chunks, each chunk including research, brainstorming, evaluation, and recommendation. The team room environment may include an area for each corresponding portion of the chunk, e.g., a first area 44 for the research portion, a second area 46 for the brainstorming portion, a third area 48 for the evaluation portion, and a fourth area 50 for the recommendation portion. In the first area 44, the user may choose one or more quantitative analyses to perform, e.g., identifying leverage points in the Buying Process. In the second area 46, the user may choose one or more specific areas where the team may brainstorm desired behaviors, e.g., in the specific stages of the Buying Process. In the third area 48, the user may choose to evaluate in further detail the desired behaviors from the list generated in the brainstorming session. The number of options to evaluate in the third area 48 depends on the number of areas the team brainstormed in the second area 46. In the fourth area 50, the user makes a recommendation and receives feedback from an embedded expert. In the Practice Case abstraction level 18, unlike the Core Concepts abstraction level 16, there is no right and wrong answer.

The user may go into each area as often as the user likes before or after making his or her recommendation. However, each option that is selected or chosen in the various areas 44, 46 and 48 has a designated timeframe associated with the choice. For example, the first area 44 may have four choices to chose from with the various choices taking anywhere from four days to ten days to complete. Selection of each choice adds the designated number of days to a virtual calendar 52 displayed in the team room. The calendar 52 shows the user how many days total the user has taken or used up during the course of the case study, e.g., the buying process analysis. At any time during the case (and repeatedly if desired), the user may seek the assistance of one of the embedded experts or display instructions for the various areas 44, 46, 48 and 50. In addition, the user may select a company tab 54 that displays background information about the company. The user may also select a data tab 56 that displays the data gathered to date from the various areas 44, 46, 48 by the user's marketing team. The user may choose to reset all the choices, which resets the calendar 52 back to zero days and deletes the data gathered from the various areas 44, 46, 48 from the data tab 56. Similar to the Core Concepts case, the user may select to return to the previous page before the user launched the interactive case at any time.

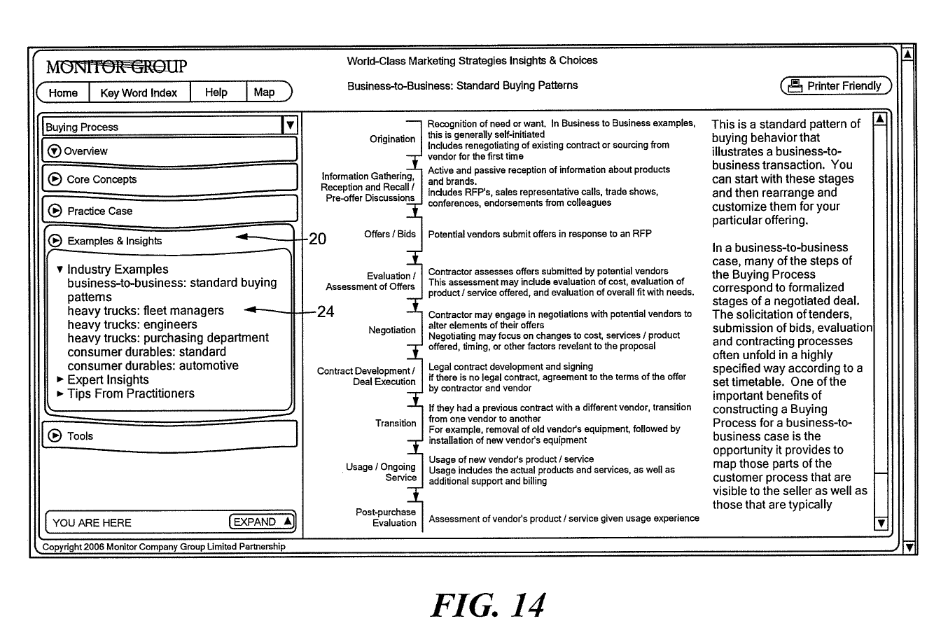

FIG. 14 shows the Buying Process subject area 10 with one section 24 selected in the Examples & Insights abstraction level 20 according to illustrative embodiments of the present invention. The Examples abstraction level 20 may provide examples from other industries with insights and tips from practitioners in the industry, e.g., marketers. This abstraction level 20 allows the user to see how the concepts and tools are applied in the real world.

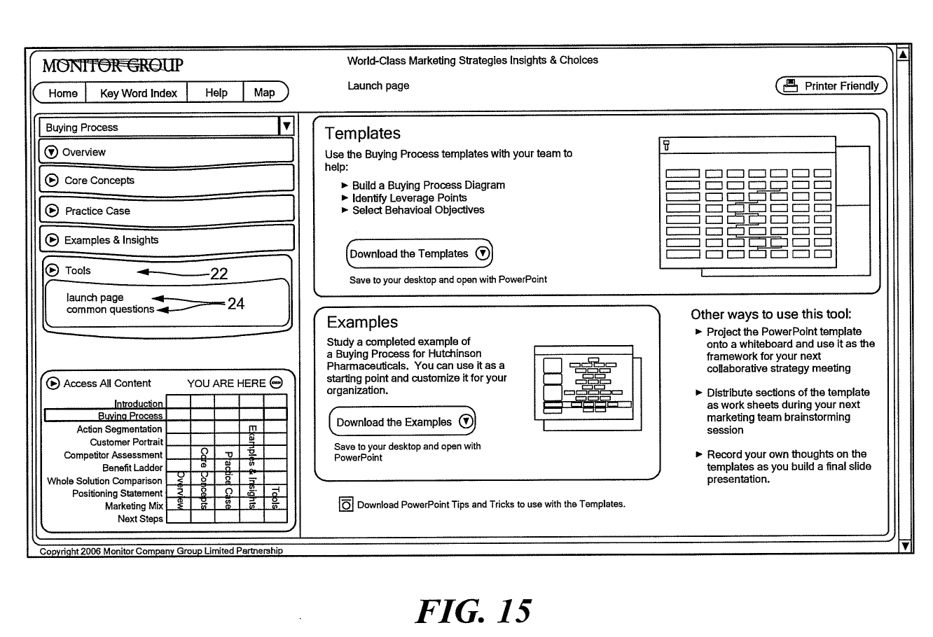

FIG. 15 shows the Buying Process subject area 10 with one section 24 selected in a Tools abstraction level 22 according to illustrative embodiments of the present invention. The Tools abstraction level 22 may provide the user with templates or examples which the user may use to customize the application of the concepts and tools learned e.g., in a buying process, for the user or the user's organization. The templates or examples may be downloaded and used in a variety of ways, e.g., projected onto a whiteboard, used during brainstorming sessions, incorporated into a slide presentation. The Tools abstraction level 22 may also provide the user with common questions for on the job assistance.

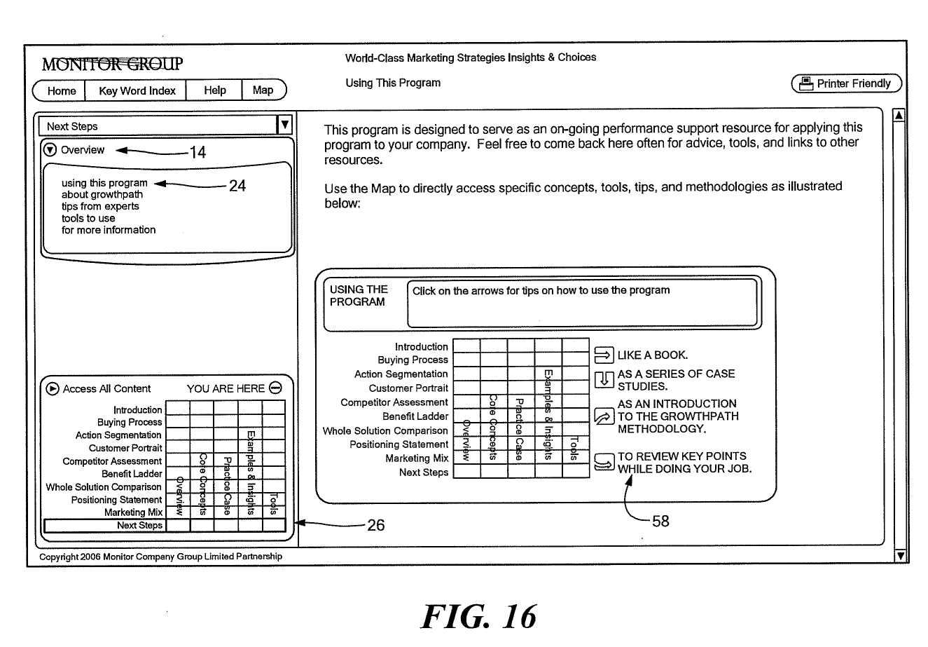

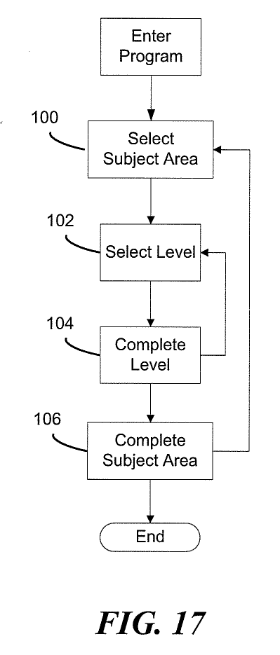

FIG. 16 shows a Next Steps subject area 10 with one section 24 selected in the Overview abstraction level 14 according to illustrative embodiments of the present invention. The Next Steps subject area appears at the end of matrix 26, after the other subject areas 10. The Next Steps subject area shows how the program may be used for further education and may include various sections, such as using this program, tips from experts, tools to use, and more information. The Next Steps subject area provides the user with tips 58 on how to use the learning environment. For example, as shown in flowchart format in FIG. 17, the user may proceed through the environment sequentially, first selecting a subject area 10 (step 100) and abstraction level 12 (step 102), e.g., the Introduction area and Overview abstraction level 14, and proceeding from left to right in each of the subject areas (repeating steps 102 and 104) until all of the abstraction levels 12 for the particular subject area have been viewed or completed (step 106) and then proceeding to the next subject area (step 100) going from top to bottom in the matrix 26.

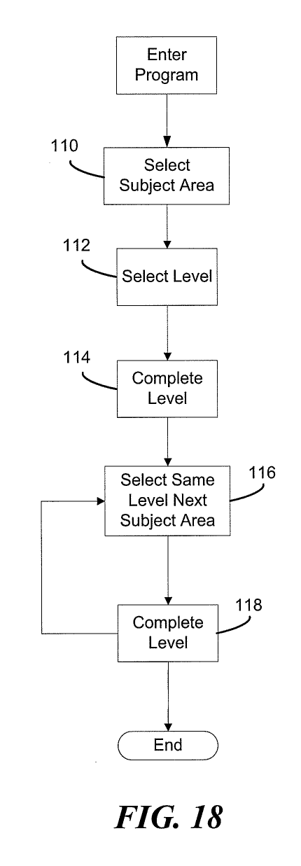

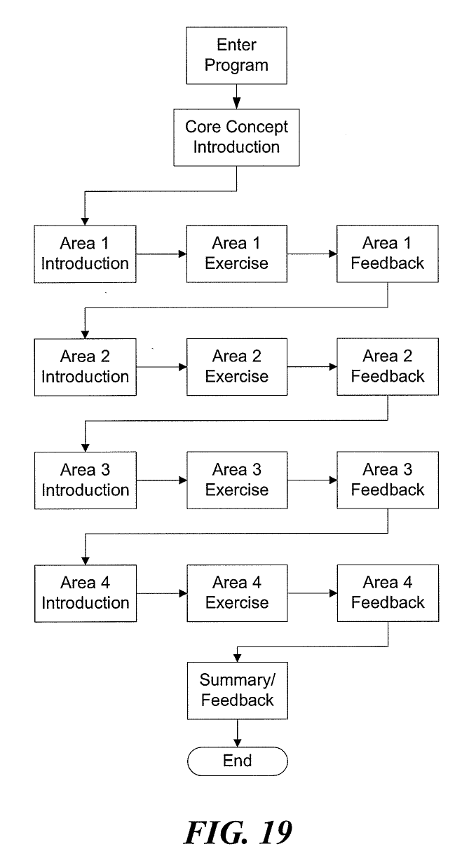

The user may also decide to proceed through the environment by reviewing one abstraction level 12 at a time for an individual subject area like a case study. For example, as shown in FIG. 18, the user may select a subject area 10 (step 110) and abstraction level 12 (step 112) and then complete that abstraction level (step 114). In step 116, the user may then select the same abstraction level 12 in a different subject area 10. The user completes the abstraction level 12 (step 118) and then repeats steps 116 and 118 until the user has proceeded to all of the desired subject areas 10. For example, the user may start with the Core Concepts abstraction level 16 and proceed from top to bottom (or in any preferred selection) through the various subject areas, such as shown in FIG. 19, e.g., going from Introduction through to Marketing Mix.

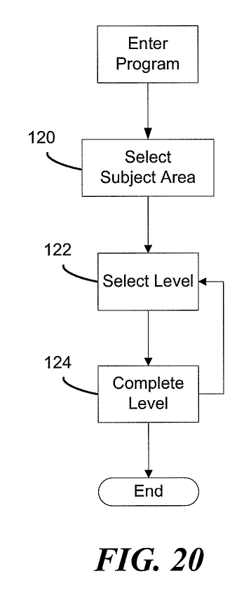

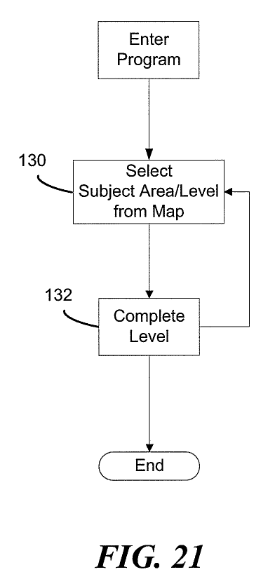

The user may also decide to proceed through the environment for one of the subject areas 10. For example, as shown in FIG. 20, the user may choose one subject area (step 120), e.g., the Introduction area, and proceed through all of its abstraction levels 12 (steps 122 and 124). The user may decide to choose one or more subject areas 10 and abstraction levels 12 in the environment in no particular order, e.g., as a review or support tool. For example, as shown in FIG. 21, the user may select a subject area 10 and abstraction level 12 from the map (step 130) and complete that one region or level (step 132). The user may then proceed to another subject area 12 and abstraction level 12 (repeating steps 130 and 132) or may choose to end the process.

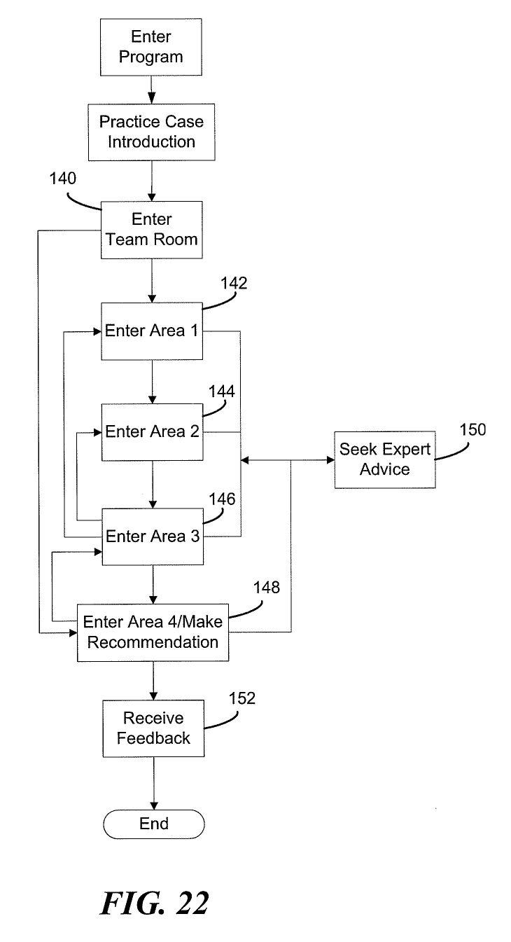

FIG. 22 shows a flow chart of a user experience in the Practice Case level 18 case study according to illustrative embodiments of the present invention. As discussed previously, the user enters the team room (step 140) and then may choose to enter the various areas 44, 46, 48 any number of times (steps 142, 144, 146) before or after making a recommendation (step 148). At any time, the user may also seek the advice of one of the embedded experts 42 (step 150). After making the recommendation in step 148, the user receives feedback in step 152 as to his or her choice from one of the embedded experts 42, e.g., described in a good, better, best manner and with a discussion of the reasons why.

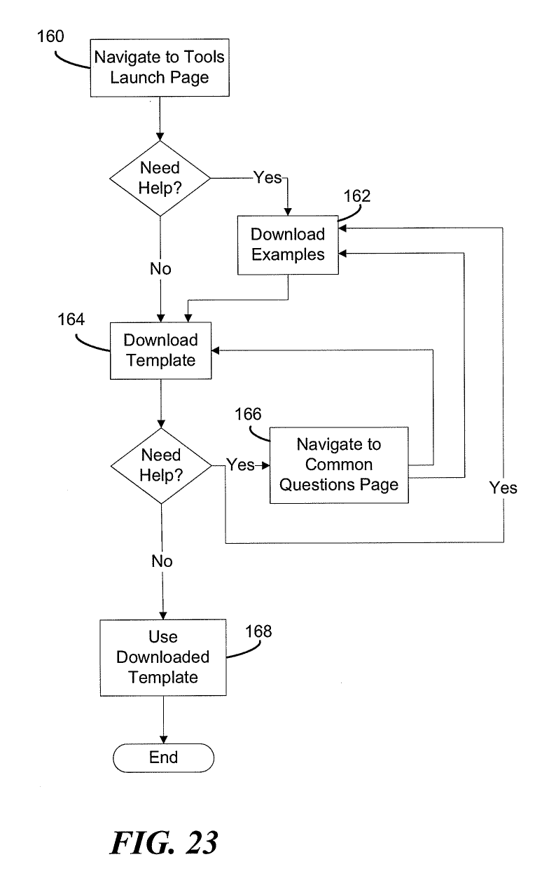

FIG. 23 shows a flow chart of a user experience in the Tools level 22 according to illustrative embodiments of the present invention. Once the user selects the Tools level 22 and Launch Page section 24 (step 160), the user may choose to download examples (step 162) if the user needs help with the templates section or the user may choose to download the templates (step 164). If the user needs some additional help, the user may navigate to a common questions page (step 166) and/or may choose to download the examples (step 162). The user may then return and download the templates (step 164). In step 168, the user may make use of the templates in a variety of ways, e.g., during a brainstorming session or preparing a slide presentation.

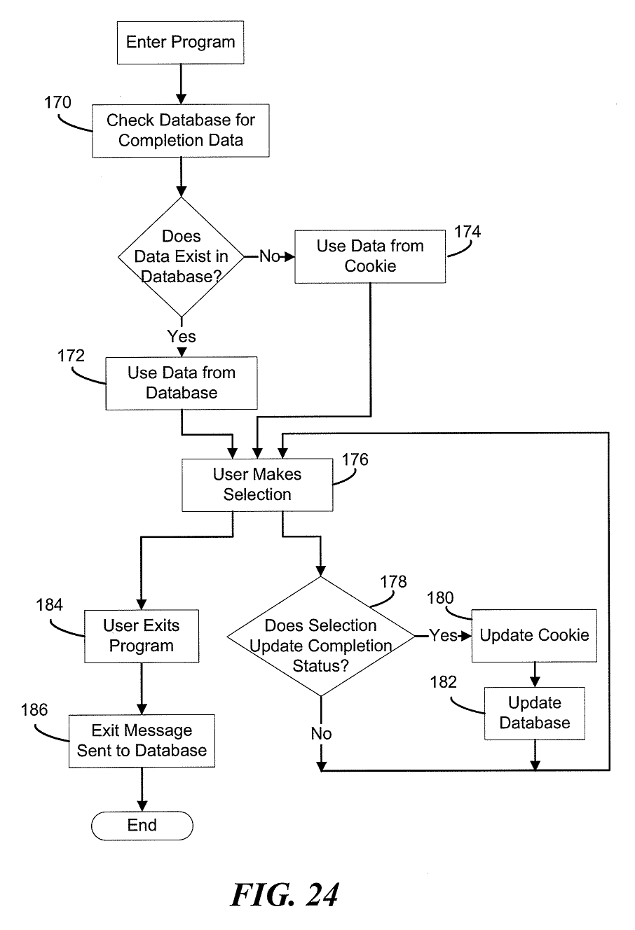

FIG. 24 shows a flow chart of data flow in the learning environment according to illustrative embodiments of the present invention. In step 170, the system checks a database for completion data to see what subject areas 10 and abstraction levels 12 the user has completed in the learning environment. If the data exists in the database, the system uses the data from the database (step 172) otherwise the system uses data from a cookie (step 174). In step 176, the user may make various selections within the environment. When a selection is made, the system verifies whether the selection necessitates updating the database or not (step 178). If the user has already been to the subject area 10 and abstraction level 12 before, the system does not need to update the database and returns to await the next selection by the user in step 176. If the user has not already been to the subject area 10 and abstraction level 12, the system updates the database (step 180), updates the cookie (step 182), and then returns to await the next selection by the user in step 176. If the user chooses to exit the program (step 184), an exit message is sent to the database in step 186.

FIG. 25 shows a user interface wireframe of a selection matrix 200 of interactive learning content 202, presentation mode 204, learning goal 206, application goal 208, and content entry point 210 according to illustrative embodiments of the present invention. The information presented is in the context of an Economic Valuation Estimation learning environment. Selection matrix 200 is a refinement over matrix 26 and allows the user greater control over learning content selection and presentation mode. Table of Contents column 202 lists learning content items available in the Economic Valuation Estimation learning environment. Mode column 204 lists modes of content delivery. The user can choose a delivery mode that he or she feels will provide a more effective learning experience. For example, the user can choose to learn the content through watch & listen, interact, read, discuss, or suggest. Learning Goal column 206 allows the user to choose the depth of knowledge he or she is interested in. For example, the user can choose from a high level awareness down to a deep or creative knowledge level. Application Goal column 208 allows the user to tailor the content to how the user intends to apply the learning. For example, the user is presented with contexts and exercises that allow him or her to apply their learning at a high “apply subskills” level down to an extend and apply level. Entry Point column 210 allows the user to choose how far into the subject matter they would like to begin. For example, the use may choose to begin with the general concept, specific concept, example, guided practice, or open practice. After the user has selected a desired content item, mode, learning goal, application goal, and entry point, they may choose to preview the content by selecting Preview button 24, or choose the Go button 214 to view the content in the mode selected.

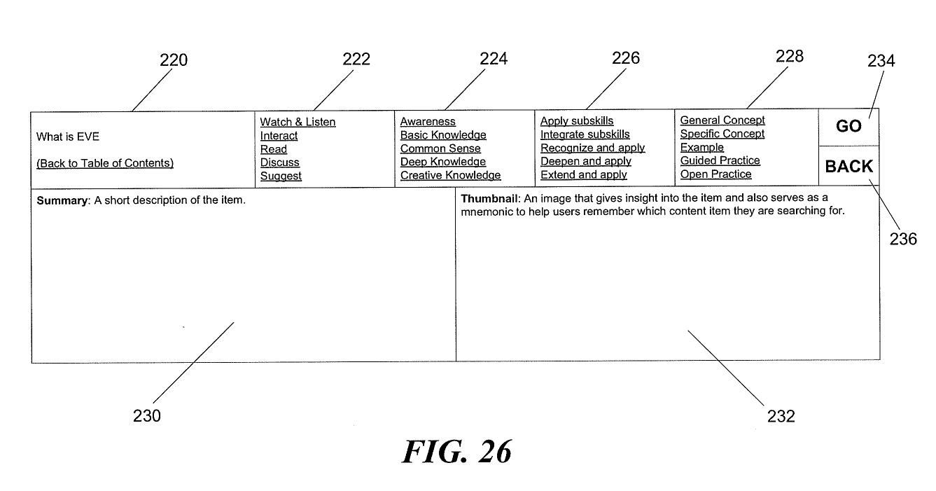

FIG. 26 shows a shows a user interface wireframe for selection of presentation mode, learning and application goals, and content entry point after the content item “What is EVE” of content has been selected from Table of Contents column 202, and the user has selected Preview 214 of FIG. 25. The user is presented with a short description of the content item in screen area 230, and a thumbnail image in screen area 232 that gives insight into the item and also serves as a mnemonic to help the user remember which content item they have chosen. As in the page display of FIG. 25, the user may select a mode 222, a learning goal 224, an application goal 226, an entry point 228, and select the Go button 234 to view the selected content 220 in the mode selected. The user may also choose to return to the previous page, as displayed in FIG. 25, by selecting the Back button 236.

FIG. 27 shows a user interface wireframe with a concept map for selection of interactive learning content according to illustrative embodiments of the present invention. The user is presented with a table of contents 250 showing subject areas. In the example shown, the user has selected subject area “What is EVE.” In screen area 252, a concept map is displayed showing the subject area 250 that is selected by the user at the center. Related concepts 254 are shown. The relationships 255 between the selected subject area 250 at the center of the concept map and the related concepts 254 is also indicated. For example, the selected subject area “EVE” is used for pricing, and is used by pricing experts. Although only relationships 255 between the selected subject area 250 at the center of the concept map and other concepts 254 are shown, relationships among concepts 254 may also be indicated. The user can also display additional relationships by selecting a displayed concept 254 and selecting the Related, In, or Out buttons, 256, 258, or 260, respectively. The In and Out buttons, 258 and 260, can be used, for example, to display different realms of the concept map (each realm relating to a different abstraction level), and sections of the “What is EVE” subject area. For example, successively deeper abstraction levels and their associated sections can be displayed with their relationships 255 indicated, by repeatedly selected the In button 258. The user can view all relationships 255 that are defined for a concept 254 by selecting the Related button 256. To view the interactive learning content, the user selects a concept 254, a mode 262, a learning goal 264, an application goal 266, an entry point 268, and selects the Go button 272. The user can also preview the learning content by selecting the Preview button 270. The user will then see the page illustrated in FIG. 26. From there, the user can then proceed to viewing the learning content, or return to concept map page of FIG. 27. Through broad definitions of the relationships between concepts in the learning environment, a concept map can allow the user the greatest flexibility in choice of interactive learning content to view.

Table 1 shows a general definition table for a concept map such as might be tailored for use for the concept map in screen area 252 of FIG. 27. Each row defines a triple, consisting of two concepts connected by an edge. For example, Concept 1 and Concept 2 are connected by an edge defined as Relationship A. As can be seen in Table 1, Concept 1 is related to Concept 2 by edge Relationship A, and to Items (i), (ii) and (iii) by edge Relationship X. In the concept map of FIG. 27, these definition triples might be, for example, EVE—“Is a Type Of”—Value Based Pricing, and EVE—“Is Used For”—Pricing, Value Communication, Product Management. Once such a concept map triples definition table is defined for an interactive learning environment, the table can be used to generate concept maps, such as the one displayed in FIG. 27, that will allow the user to navigate through and select any learning environment content item the user desires.

TABLE 1
Concept Map - Triples Definitions
Concept Map - Triples Definitions

| Concept | Edge | Concept |
|---|---|---|
| Concept 1 | Relationship A | Concept 2 |
| Concept 2 | Relationship B | Concept 3 |
| Concept 4 | Relationship A | Concept 5 |
| Concept 3 | Relationship C | Concept 5 |
| Concept 6 | Relationship D | Concept 1 |
| Concept 1 | Relationship X | Item (i) |
| Concept 2 | Relationship Y | Item (i) |
| Concept 1 | Relationship X | Item (ii) |
| Concept 2 | Relationship Y | Item (ii) |
| Concept 1 | Relationship X | Item (iii) |
| Concept 2 | Relationship Z | Item (iii) |

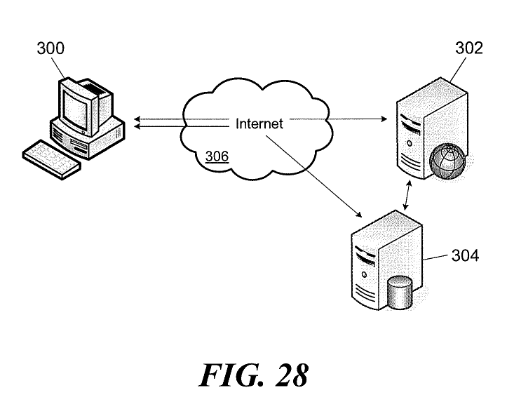

FIG. 28 shows a high-level hardware architecture according to an illustrative embodiment of the present invention. In one illustrative embodiment, a user at a general purpose personal computer or workstation (PC) 300 interacts with the interactive learning environment of the embodiment residing on a web server 302. Both PC 300 and web server 302 are connected to, and communicate over, the Internet 306. An optional database server 304 is also shown that may communicate with PC 300 over the Internet 306, and directly with web server 302. The learning environment user at PC 300 invokes a web browser resident on PC 300, and requests a connection to the interactive learning environment. The user then interacts with the learning environment logic residing on the web server via the web browser. In other embodiments of the present invention, PC 300 and web server 302 may communicate over a managed network, such as a local area network. It is also contemplated that the interactive learning environment may reside entirely on PC 300. While specific embodiments have been described and suggested, any suitable arrangement of hardware and logic that will allow the user to interact with the interactive learning environment of the present invention are contemplated to be within the invention.

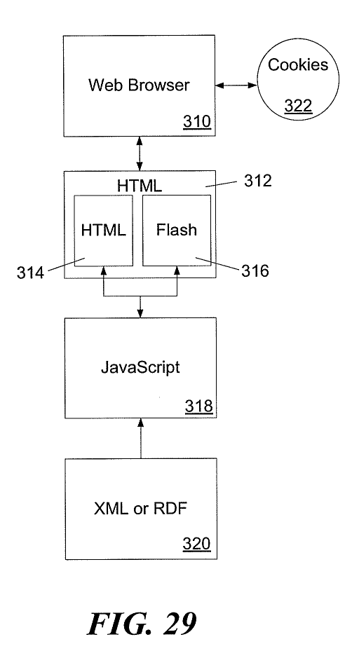

FIG. 29 shows a block diagram of a software architecture according to an illustrative embodiment of the present invention. The user interacts with the learning environment via web browser 310. Web browser 310 communicates with the interactive learning environment HTML pages 312. These pages may contain or link to learning content of any type and from any subject area, and may also contain navigational user interfaces for moving between pages or items of learning content. For example, a web page 312 may contain HTML language and scripts 314, and Flash content and scripts 316. Web browser 310 may maintain cookies 322 to track navigation, usage, and learning completion data. The presentation and control of HTML pages 312 can be accomplished with JavaScript 318. XML or RDF files 320 can be used as configuration files to structure the navigational user interfaces the user sees via HTML files 312. In this illustrative embodiment of a hardware and software architecture, the use of a database, content management system, and web application server are not required. The embodiment can be implemented in a basic web server and browser configuration. While a specific embodiment have been described, those skilled in the art will appreciate that other software architectures, languages, and tools can be used. In general, any suitable combination of logic, interfaces, and content presentation that will allow the user to interact with the interactive learning environment of the present invention are contemplated to be within the invention.

Although the above discussion discloses various exemplary embodiments of the invention, it will be apparent that those skilled in the art can make various modifications that will achieve some of the advantages of the invention without departing from the true scope of the invention. For example, various names have been used in the above discussion and the claims with respect to the various abstraction levels and portions of chunks. It will be apparent to those skilled in the art, however, that other terms may be used with various embodiments of the present invention. Specific hardware and software embodiments are shown. However, any suitable arrangement of hardware and software, however discrete or integrated, that accomplishes the goals of the invention may be used.

What is claimed is:

1. A method of providing a personalized learning experience, under computer program control, to a user, the method comprising:
displaying graphically a listing of subject areas offered to the user, each subject area having a plurality of distinctly labeled abstraction levels, also displayed graphically; and
receiving a graphical selection by the user of a desired subject area and a desired abstraction level from the displayed listing, and, on receipt of a user command in relation to such selection, moving program control of the experience to the desired subject area and the desired abstraction level, so as to enable the user to proceed in a direction and manner of the user's choosing consistent with the user's needs of the moment.

2. A method according to claim 1, wherein displaying the listing and the abstraction levels includes displaying the listing along a first axis and displaying the abstraction levels along a second axis orthogonal to the first axis.

3. A method according to claim 2, wherein displaying the listing and the abstraction levels further includes displaying a matrix in which a separate graphically accessible region is defined by the intersection of a specific subject area on the first axis and a specific abstraction level on the second axis, such separate region being graphically selectable, so that selection of the desired subject area and the desired abstraction level is accomplished by graphical selection of the region in the matrix corresponding to the desired subject area and the desired abstraction level.

4. A method according to claim 3, further comprising:
displaying an indicator in the matrix to identify the location of program control to the user.

5. A method according to claim 1, further comprising:
displaying a summary of the desired subject area following receiving the graphical selection and before receipt of the user command.

6. A method according to claim 1, wherein at least one of the abstraction levels includes chunks; and wherein the abstraction levels displayed include at least two members selected from the group including overview, core concepts, practice case, examples, and tools.

7. A method according to claim 6, wherein one of the abstraction levels is core concepts and one chunk includes exposition, contextualization, interaction, and framing.

8. A method according to claim 7, wherein the interaction includes a capability of finishing a task for the user.

9. A method according to claim 6, wherein one of the abstraction levels is practice case and one chunk includes research, brainstorming, evaluation, and recommendation.

10. A method according to claim 6, wherein one of the abstraction levels is practice case and one chunk is graphically presented in a team room.

11. A method according to claim 6, wherein one of the abstraction levels is practice case and the method further comprises permitting selection of a portion of one chunk in a recursive manner.

12. A method according to claim 1, wherein at least one of the abstraction levels is divided into sections.

13. A method according to claim 12, wherein one of the abstraction levels is overview and one of the sections includes use of a visual metaphor.

14. A method of providing a personalized learning experience, under computer program control, to a user, the method comprising:
providing an interactive learning environment in a computer system, the environment established by a series of interactive media elements, the elements covering selected subject areas offered to the user, wherein
each of the subject areas is systematically divided into abstraction levels including at least two members selected from the group including overview, core concepts, practice case, examples, and tools;
providing in the environment a graphical navigation tool permitting the user to navigate graphically in the environment to any desired subject area and any desired abstraction level, so as to enable the user to proceed in a direction and manner of the user's choosing consistent with the user's needs of the moment.

15. A method according to claim 14, further comprising:
displaying the listing along a first axis and displaying the abstraction levels along a second axis orthogonal to the first axis.

16. A method according to claim 15, wherein displaying the listing and the abstraction levels further includes displaying a matrix in which a separate graphically accessible region is defined by the intersection of a specific subject area on the first axis and a specific abstraction level on the second axis, such separate region being graphically selectable, so that selection of the desired subject area and the desired abstraction level is accomplished by graphical selection of the region in the matrix corresponding to the desired subject area and the desired abstraction level.

17. A method according to claim 16, further comprising:
displaying an indicator in the matrix to identify the location of program control to the user.

18. A method according to claim 14, wherein at least one of the abstraction levels includes chunks.

19. A method according to claim 18, wherein one of the abstraction levels is core concepts and one chunk includes exposition, contextualization, interaction, and framing.

20. A method according to claim 19, wherein the interaction includes a capability of finishing a task for the user.

21. A method according to claim 18, wherein one of the abstraction levels is practice case and one chunk includes research, brainstorming, evaluation, and recommendation.

22. A method according to claim 18, wherein one of the abstraction levels is practice case and one chunk is graphically presented in a team room.

23. A method according to claim 18, wherein one of the abstraction levels is practice case and the method further comprises permitting selection of a portion of one chunk in a recursive manner.

24. A method according to claim 14, wherein at least one of the abstraction levels is divided into sections.

25. A method according to claim 24, wherein one of the abstraction levels is overview and one of the sections includes use of a visual metaphor.

26. A computer program product for providing a personalized learning experience to a user, the computer program product comprising a computer usable medium having computer readable program code thereon, the computer readable program code comprising:
program code for displaying graphically a listing of subject areas offered to the user, each subject area having abstraction levels, also displayed graphically, including at least two members selected from the group including overview, core concepts, practice case, examples, and tools; and
program code for permitting graphical selection by the user of a desired subject area and a desired abstraction level from the displayed listing, whereupon, on such selection, program control of the experience moves to the desired subject area and the desired abstraction level, so as to enable the user to proceed in a direction and manner of the user's choosing consistent with the user's needs of the moment.

27. A computer program product according to claim 26, wherein program code for displaying the listing and the abstraction levels includes program code for displaying the listing along a first axis and displaying the abstraction levels along a second axis orthogonal to the first axis.

28. A computer program product according to claim 27, wherein program code for displaying the listing and the abstraction levels further includes program code for displaying a matrix in which a separate graphically accessible region is defined by the intersection of a specific subject area on the first axis and a specific abstraction level on the second axis, such separate region being graphically selectable, so that selection of the desired subject area and the desired abstraction level is accomplished by graphical selection of the region in the matrix corresponding to the desired subject area and the desired abstraction level.

29. A computer program product according to claim 28, further comprising:
program code for displaying an indicator in the matrix to identify the location of program control to the user.

30. A computer program product according to claim 26, wherein at least one of the abstraction levels includes chunks.

31. A computer program product according to claim 30, wherein one of the abstraction levels is core concepts and one chunk includes exposition, contextualization, interaction, and framing.

32. A computer program product according to claim 31, wherein the interaction includes a capability of finishing a task for the user.

33. A computer program product according to claim 30, wherein one of the abstraction levels is practice case and one chunk includes research, brainstorming, evaluation, and recommendation.

34. A computer program product according to claim 30, wherein one of the abstraction levels is practice case and one chunk is graphically presented in a team room.

35. A computer program product according to claim 30, wherein one of the abstraction levels is practice case and the product further comprises program code for permitting selection of a portion of one chunk in a recursive manner.

36. A computer program product according to claim 26, wherein at least one of the abstraction levels is divided into sections.

37. A computer program product according to claim 36, wherein one of the abstraction levels is overview and one of the sections includes use of a visual metaphor.

38. A method of providing a personalized learning experience, under computer program control, to a user, the method comprising:
displaying graphically a listing of subject areas offered to the user, wherein presentation of each subject area is selectable by the user according to a matrix of attributes affecting the presentation;
wherein the matrix includes at least two dimensions selected from the group consisting of mode, learning goal, application goal, and entry point; and
receiving a graphical selection by the user of a desired subject area and a desired attribute from each dimension of the matrix, and on receipt of a command in relation to such selection, presenting content consistent with such selection, so as to enable the user to select both the subject area and a plurality of attributes affecting presentation to the user of the desired subject area.

39. A method according to claim 38, wherein displaying graphically the list of subject areas includes displaying a concept map of the subject areas.

40. A method according to claim 39, wherein receiving a graphical selection by the user of the desired subject area includes the selection via graphical indication in the concept map.

41. A method according to claim 40, further comprising:
receiving a graphical selection from the user indicating a realm of the concept map to be displayed and causing display of the realm in response thereto.

42. A method according to claim 38, wherein the mode dimension of the matrix includes at least two attributes selected from the group consisting of watch and listen, interact, read, discuss, and suggest.

43. A method according to claim 38, wherein the learning goal dimension of the matrix includes at least two attributes selected from the group consisting of awareness, basic knowledge, common sense, deep knowledge, and creative knowledge.

44. A method according to claim 38, wherein the application goal dimension of the matrix includes at least two attributes selected from the group consisting of apply subskills, integrate subskills, recognize and apply, deepen and apply, and extend and apply.

45. A method according to claim 38, wherein the entry point dimension of the matrix includes at least two attributes selected from the group consisting of general concept, specific concept, example, guided practice, and open practice.
